(19) United States
(12) Patent Application Publication
(10) Pub. No.: US 2018/0131027 A1
(43) Pub. Date: May 10, 2018

(54) FLEXIBLE INORGANIC FUEL CELL MEMBRANE

(71) Applicants: Charles Austen Angell, Mesa, AZ (US); Younes Ansari, Medford, MA (US); Telpriore Greg Tucker, Phoenix, AZ (US); Iolanda Santana Klein, Tempe, AZ (US)

(72) Inventors: Charles Austen Angell, Mesa, AZ (US); Younes Ansari, Medford, MA (US); Telpriore Greg Tucker, Phoenix, AZ (US); Iolanda Santana Klein, Tempe, AZ (US)

(21) Appl. No.: 15/575,851

(22) PCT Filed: May 26, 2016
(86) PCT No.: PCT/US16/34448

§ 371 Date: Nov. 21, 2017

Related U.S. Application Data
(60) Provisional application No. 62/166,424, filed on May 26, 2015.

(51) Int. Cl. H01M 8/1034; H01M 8/1051; H01M 8/1072

(52) U.S. Cl. CPC H01M 8/1034; H01M 8/1051; H01M 8/1072; H01M 2300/0094; H01M 2300/0068; H01M 2300/0085; H01M 2300/0091; H01M 2300/0008

(57) ABSTRACT

A solid electrolyte includes an amorphous silica network and phosphoric acid. The phosphoric acid is contained in the amorphous silica network, and is typically in molecular form. The ratio of silicon to phosphorus in the solid electrolyte is about 1:4, and the silicon is in a four-coordinated state. The solid electrolyte is in the form of a dried (e.g., anhydrous) gel. The solid electrolyte may be used in a fuel cell membrane. Preparing the solid electrolyte includes reacting phosphoric acid in the liquid state with tetrachloride compound including silicon and a displaceable ligand to yield a fluid suspension, heating the fluid suspension to yield a liquid electrolyte comprising a particulate solid, separating the particulate solid from the liquid electrolyte, combining the particulate solid with water to yield a homogenous solution, forming a gel from the homogeneous solution, and removing water from the gel to yield the solid electrolyte.

### CROSS-REFERENCE TO RELATED APPLICATIONS

This application claims priority to U.S. Application Ser. No. 62/166,424 entitled “FLEXIBLE INORGANIC FUEL CELL MEMBRANE” and filed on May 26, 2015.

### STATEMENT OF GOVERNMENT INTEREST

This invention was made with government support under W911NF-07-G-0423 and W911NF-11-1-1-0263 awarded by the Army Research Office. The government has certain rights in the invention.

### TECHNICAL FIELD

This invention relates to a flexible inorganic fuel cell with high conductivity and temperature stability.

### BACKGROUND

The search for fuel cell membranes has focused on carbon backbone polymers, among which only NAFION seems to survive the most severe of the degradation mechanisms—attack by peroxide radicals. Less attention has been given to inorganic membranes because of their generally inflexible nature and lower conductivity, though some SiO₂-NAFION composites have shown improved properties. NAFION dominates, despite needing hydration, which then restricts operation to below 100° C., such that CO poisoning problems persist.

Proton exchange membrane fuel cells (PEMFCs) are potential non-polluting power sources that may be an efficient means of converting chemical energy of a combustion reaction to electrical energy and thence mechanical work. However, practical realization of this efficiency, even in the simple H₂/O₂ fuel cell case, has been difficult. NAFION fuel cells based on sulfonated polytetrafluoro-ethylene proton-conducting membranes are favored for their high conductivities and degradation resistance, but are limited to temperatures below 100° C. because of loss, at higher temperatures, of the water needed for high conductivity. This means that the fuel cell is susceptible to catalyst poisoning by CO impurities in the fuel gas, which therefore must be super-pure. The NAFION-based cells also suffer from acute water crossover, hence water management problems.

Attempts have been made to increase the operating temperature of the NAFION membrane cell by (1) operating the cell under pressure or (2) doping phosphoric acid solutions into NAFION-based composite membranes. Both methods give results that are favorable as alternatives to the pristine NAFION membrane cell. However, NAFION and other perfluorinated polymer electrolytes (e.g., FLEMION, and ACIPLEX) are limited in commercial applications because of the high materials costs, coupled with the reduced performance at high temperatures.

### SUMMARY

In a first general aspect, a composition includes an amorphous silica network and phosphoric acid, where the phosphoric acid is contained in the amorphous silica network.

Implementations of the first general aspect may include one or more of the following features. The phosphoric acid is typically in molecular form. The composition may be all inorganic. The ratio of silicon to phosphorus in the composition is about 1:4, and the silicon is in a four-coordinated state. The composition is in the form of a dried gel. The dried gel may be anhydrous. The composition may be in the form of a solid electrolyte.

The composition is chemically stable up to 150° C. The conductivity of the composition exceeds 200 mS/cm at 100° C., or 300 mS/cm at 100° C.

In a second general aspect, a fuel cell membrane includes the composition of the first general aspect.

Implementations of the second general aspect may include one or more of the following features.

The fuel cell membrane may include a substrate. The substrate is typically flexible. The substrate is typically porous, and may be in the form of a mesh, a matrix, a screen, a porous paper, or a porous polymer. In one example, the substrate includes glass fiber or glass wool. The substrate may be coated with the composition. In some cases, the substrate is embedded in the composition.

In a third general aspect, a fuel cell includes the fuel cell membrane of the second general aspect.

In a fourth general aspect, preparing a fuel cell membrane includes reacting phosphoric acid in the liquid state with a compound comprising silicon and a displaceable ligand to yield a fluid suspension, heating the fluid suspension to yield a liquid electrolyte comprising a particulate solid, separating the particulate solid from the liquid electrolyte, combining the particulate solid with water to yield a homogenous solution, contacting a substrate with the homogeneous solution, and removing water from the homogenous solution to yield the fuel cell membrane comprising the substrate embedded in a solid electrolyte.

Implementations of the fourth general aspect may include one or more of the following features.

The compound including silicon and a displaceable ligand may be a silicon halide (e.g., silicon tetrachloride, silicon tetrabromide), a substituted or unsubstituted chlorophenyl silane, tetraphenyl silane, or the like. The phosphoric acid and compound including silicon and chlorine are combined with a silicon to phosphorus ratio of about 1:4. The solid electrolyte is in the form of a flexible, dried (e.g., anhydrous) gel. The solid electrolyte is in the form of an amorphous silica network containing phosphoric acid. The phosphoric acid is typically in molecular form. The solid electrolyte is proton conductive.

Thus, particular embodiments have been described. Variations, modifications, and enhancements of the described embodiments and other embodiments can be made based on what is described and illustrated. In addition, one or more features of one or more embodiments may be combined. The details of one or more implementations and various features and aspects are set forth in the accompanying drawings, the description, and the claims below.

### BRIEF DESCRIPTION OF THE DRAWINGS

FIG. 1 is a flowchart showing a process for preparing a dried SiPOH gel (SiPOHgel).

FIG. 2A shows a drying curve showing the loss of mass from a SiPOH gel. FIG. 2B is an image of SiPOHgel.

FIG. 3 shows conductivity of SiPOHgel at temperatures up to 150° C., compared with that of NAFION samples from different studies.

FIG. 4 depicts an exploded view of a sandwich type cell used for fuel cell testing.

FIG. 5 shows Tafel plots (IR corrected) for fuel cells with pristine SiPOHgel (pure SiPOHgel) and stabilized SiPOHgel (membranes coated with SiPOHgel).

FIG. 6 shows polarization curves (linear current and no IR correction) for fuel cells with pristine SiPOHgel and stabilized SiPOHgel membranes.

FIG. 7 shows degradation testing of a SiPOHgel membrane at various conditions and compared to two other studies.

FIG. 8 shows ¹H and ³¹P nuclear magnetic resonance (NMR) spectra of SiPOHgel.

FIG. 9 shows solid state ²⁹Si magic angle spinning (MAS)-NMR spectra of SiPOH paste and SiPOHgel.

FIG. 10A shows ²⁹Si MAS-NMR spectra for SiPOHgel, SiPOHgel-K, and nanosphere SiO₂. FIG. 10B shows Cu⁺ enhanced ²⁹Si MAS-NMR specta of pure silica MCM-41 zeolite structure.

FIG. 11 shows XRD patterns for SiPOHgel and anhydrous silica gel.

FIG. 12 depicts a proposed structure of SiPOHgel.

### DETAILED DESCRIPTION

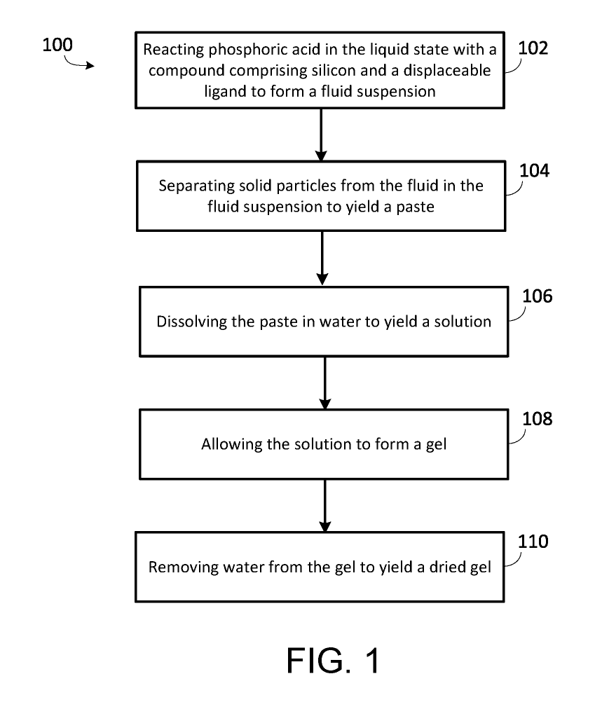

The solid electrolyte described herein is a dried gel that may be prepared by process 100 shown in the flowchart of FIG. 1. In 102, phosphoric acid (H₃PO₄) in the liquid state is reacted with a compound including silicon and a displaceable ligand to yield a fluid suspension (a “SiPOH” suspension). The displaceable ligand may be a phenyl group, halide, or the like. In some examples, the compound including silicon and the displaceable ligand is a silicon halide (e.g., silicon tetrachloride, silicon tetrabromide), a substituted or unsubstituted chlorophenyl silane, tetraphenyl silane, or the like. As used herein, “SiPOH” refers to a silicophosphoric acid or a mixture of two or more silicophosphoric acids, each having a different chemical formula, where “silicophosphoric acid” (or “siphoric acid”) is an acidic molecular inorganic compound including silicon and phosphorus. Typically, the phosphoric acted reacted in 102 is anhydrous phosphoric acid. The anhydrous phosphoric acid may be formed, for example, by fusion of pure (>99%) phosphoric acid in the solid state. The phosphoric acid and the compound including silicon and the displaceable ligand are typically combined in a Schlenk flask under nitrogen atmosphere in a Si:P ratio of about 1:4. The mixture may be heated (e.g., to about 50° C.) for a length of time (e.g., about 2 h). When the displaceable ligand is chlorine, HCl bubbles evolve during the reaction. In some cases, a HCl trap may be used to trap the evolved HCl. The mixture may be heated further (e.g., at 120° C.) for a length of time (e.g., 4 h). The resulting fluid suspension, including SiPOH as a white solid and excess phosphoric acid, is creamy in appearance, and scatters incident visible light.

In 104, solid SIPOH particles are separated from the fluid in the fluid suspension to yield a SiPOH paste, from which most of the excess phosphoric acid has been separated. In one example, separating the solid particles from the fluid in the fluid suspension is achieved by centrifuging the fluid suspension to yield a paste. The paste is separated from the fluid, and may be washed with an unreactive solvent (e.g., pentafluoropropanol).

In 106, the SiPOH paste is dissolved in water to yield a SiPOH solution. Water and SiPOH may be mixed in a water: SiPOH weight ratio of about 3:2 to about 5:2.

In 108, the SiPOH solution is allowed to form a gel. A gel is formed by allowing the SiPOH solution to stand (e.g., at room temperature for a number of hours). The initial gel is a mechanically frail material.

In 110, water is removed from the SiPOH gel to yield a solid, flexible electrolyte in the form of rubbery dried silico-phosphoric acid gel, referred to herein as “SiPOHgel.” When water is removed from the gel, the gel shrinks away from the edges of the vessel in which it is contained, and strengthens into a rubbery button as water is removed. In one example, water is removed by vacuum oven drying (e.g., at 40° C. for 15 h) followed by room temperature vacuum drying (e.g., for 9 h). In some cases, SiPOHgel is anhydrous.

In one example, SiPOHgel was prepared as follows. Phosphoric acid and silicon tetrachloride were added to a Schlenk flask under nitrogen atmosphere in a ratio of 7:3 by weight. The mixture was kept at 50° C. for 2 h. The phosphoric acid melted completely, and HCl bubbles evolved. Then the temperature was slowly increased to 120° C. for 4 h. The final product was a white suspension, including SiPOH (white solid) and excess phosphoric acid. The excess phosphoric acid was separated by centrifugation, and the remaining solid was washed several times with pentafluoropropanol (inert with respect to SiPOH). 2.8 g of water were added to 1.2 g of SiPOH, which dissolved completely. A quartz membrane (Cole Parmer QR-200 Tokyo Roshi Kaisha Ltd), initially 1.5 mm in thickness, was added to the solution as the substrate for the gel. After vacuum drying at 40° C. for 15 h, and room temperature vacuum drying for another 9 h, SiPOH was formed as a colorless, transparent, soft gel. The total weight loss was 66%, corresponding to a 95% loss of the added water.

SiPOH and SiPOHgel used for durability testing were prepared in a closed system comprised of a 3-neck Schlenk reaction flask. One of the joints contained a cold finger kept at around −20° C. and the other was attached to a tube containing a HCl trap. The HCl trap was a liquid mixture of two adducts: diethylmethylamine/aluminum chloride and 2-methylpyridine/aluminum chloride (70:30% in weight) which absorb HCl to form a mixed protic ion liquid of low liquidus temperature.

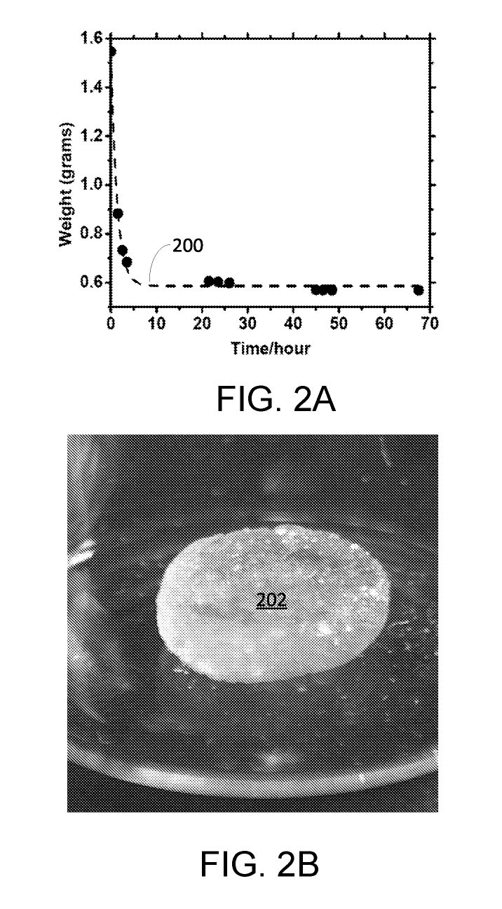

FIG. 2A shows plot 200 of weight loss (g) versus time (h) for a wet SiPOH gel to yield O (OK) (OK)SiPOHgel. The plot shows loss of 90% of the initial water content in the gel mass during vacuum drying with periodic weight recording. The weight loss is rapid at first, and constant mass is reached after about 15 h, as vapor pressure approaches zero. The resulting SiPOHgel is flexible, and may be in the form of a disc or button, depending on the shape of the vessel in which the gel is dried.

FIG. 2B shows an image of SiPOHgel 202 prepared as described in process 100 and dried as described with respect to FIG. 2A. SiPOHgel is translucent and may vary from pale yellow to colorless. This flexible, rubbery material contains little or no free water (i.e., heating at 300° C. is accompanied by a mass loss of only 10 wt %, and the weight of the dry, crystalline, hygroscopic, powdery material remains almost unchanged when the temperature is raised to 600° C.). As an additional measure of its stability, SiPOHgel is generally stable at temperatures up to 150° C.

SiPOHgel is understood to include sequestered phosphoric acid in a flexible nano-permeated amorphous zeolitic network of pure silica (e.g., defect-free and open network). SiPOHgel contains silicon in a six coordinated state, according to ²⁹Si NMR spectroscopy, and X-ray diffractometry (XRD) indicates high disorder. According to inductively coupled plasma (ICP) analysis of SiPOHgel after washing with an unreactive solvent (e.g., pentafluoropropanol), SiPOHgel has a Si:P ratio of 1:4.

Calcined powder formed from SiPOHgel has an XRD pattern that has not been indexed to any known structure, and is distinct from any of the structures seen to result from calcination of SiPOH particles. It is understood that the structure of the nearest crystal is characterized by a complex and extended medium range order of low symmetry.

### Conductivity and Fuel Cell Performance of SiPOHgel

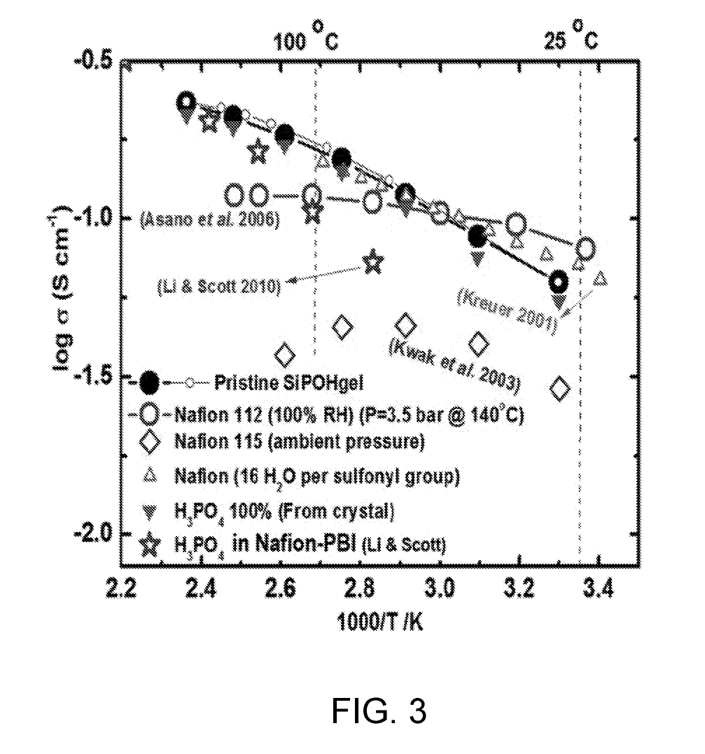

The conductivity of SiPOHgel formed as described with respect to FIG. 1 was measured on a sample cut from an anhydrous flexible button such as that shown in FIG. 2B and dried 15 h in a vacuum oven at 40° C. before incorporation in a cell. The conductivity was determined using a piston type cell with stainless steel electrodes (and mild spring compression for good electrode contact), assembled under dry nitrogen. The results are shown in FIG. 3. Comparison is made with data from other reports on NAFION membranes measured under different conditions of hydration and pressure, with pure phosphoric acid from the melted crystal, and with the most highly conducting H₃PO₄/PBI type membrane available (a PBI-NAFION composite). The stability of the present sample at temperatures up to 150° C. is demonstrated by the agreement of data obtained during heating with data taken during subsequent cooling.

FIG. 3 shows conductivity of SiPOHgel at temperatures up to 150° C., compared with those of NAFION samples from different authors (identified in the legend) using high hydration, pressure and humidification. Data for the solid electrolyte is shown by the large, solid circles (points obtained during heating) and small open circles (obtained during cooling), to confirm high temperature stability. Data for H₃PO₄ 100% and H₃PO₄ imbibed in NAFION-PBI, are included for comparison. Comparison is made with data from four separate references (Kreuer, J. Membrane Sci. 185 (2001) 29; Asano et al., J. Am. Chem. Soc., 128 (2006) 1762; and Kwak et al., Solid State Ionics, 160 (2003) 309; and Li et al., Electrochim. Acta 55 (2010) 212, all of which are incorporated by reference herein) on NAFION membranes measured under different conditions of hydration and pressure.

The conductivity of SiPOHgel is seen to meet or exceed the conductivity of all other samples at any temperature above 60° C. The most impressive comparison is that with 100% H₃PO₄, known for its anomalous proton conductivity. The closest competition by a solid material comes from a phosphoric acid-PB-NAFION composite. At the highest temperature these conductors are only 1.5 decades from the theoretical (infrared) limit for ionic conductivity (10 Scm⁻²). In consequence at least in part of the low water content and the higher operating temperature that is permitted, neither 100% H₃PO₄ nor phosphoric acid-PB-NAFION composite will incur the water management problems that afflict the NAFION membranes.

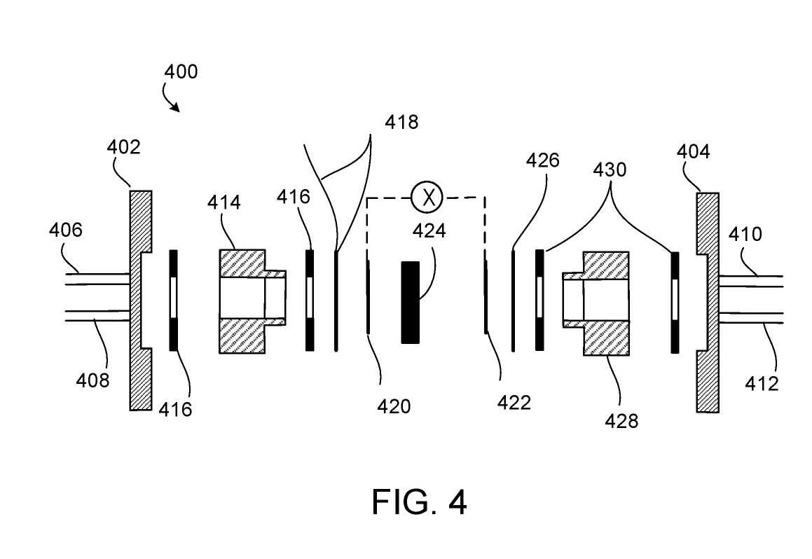

A slice from a SiPOH button, such as that shown in FIG. 2B, was tested as a membrane in a sandwich fuel cell of the type used by Belieres et al. in “Binary inorganic ionic salt mixtures as high conductivity electrolytes for >100° C. fuel cells,” Chem. Commun. (Cambridge) 4799 (2006), which is incorporated by reference herein, and also depicted, in exploded view, in FIG. 4.

Fuel cell 400 depicted in FIG. 4 includes end caps 402 and 404. End cap 402 has conduits 406 and 408 for use as an inlet and outlet, respectively. End cap 404 has conduits 410 and 412 for use as an inlet and outlet, respectively. In one embodiment, fuel is provided as hydrogen entering through conduit 406. The hydrogen flows through TEFLON spacer 414, positioned between gaskets 416, and contacts anode catalyst 418. Anode catalyst 418 may be, for example, a platinum mesh coupled to a platinum wire. Anode catalyst 418 breaks down the hydrogen into electrons and hydrogen ions. The electrons flow from anode 420 to cathode 422 via a load. The hydrogen ions flow from anode 420 through electrolyte 424 past cathode 422 to cathode catalyst 426. With an oxygen-containing gas flowing into fuel cell 400 via conduit 410 in end cap 404, cathode catalyst 426 converts the hydrogen ions to “waste” chemicals, such as water, that flow through TEFLON spacer 428 between gaskets 430 and exit via conduit 412, along with unused gas that enters via conduit 410. Excess fuel flows out of fuel cell 400 via outlet 408 in end cap 402.

Anode 420 and cathode 426 may be, for example, E-TEK carbon-Pt electrodes. Electrolyte 424 is a solid electrolyte such as a slice of the solid electrolyte button shown in FIG. 2B (“pristine SiPOHgel”), or a substrate (e.g., mesh) coated at least partially with a solid electrolyte. A coated substrate may be prepared by contacting a substrate (e.g., a porous material, such as a mesh, matrix, or the like) with a SiPOH solution. In one example, the substrate is a filter disc, such as a 1″ fiber glass filter disc. The substrate may be immersed in the SiPOH solution. The substrate, impregnated with the SiPOH solution, is then removed and allowed to dry. As water is removed (e.g., evaporated) from the substrate, the solid electrolyte envelops the surfaces (e.g., fibers) of the porous material. After the solid electrolyte is dry, the coated substrate may be used as a membrane, sized, or further processed as desired. The solid electrolyte is held between electrodes 420 and 422 and secured via end caps 402 and 404.

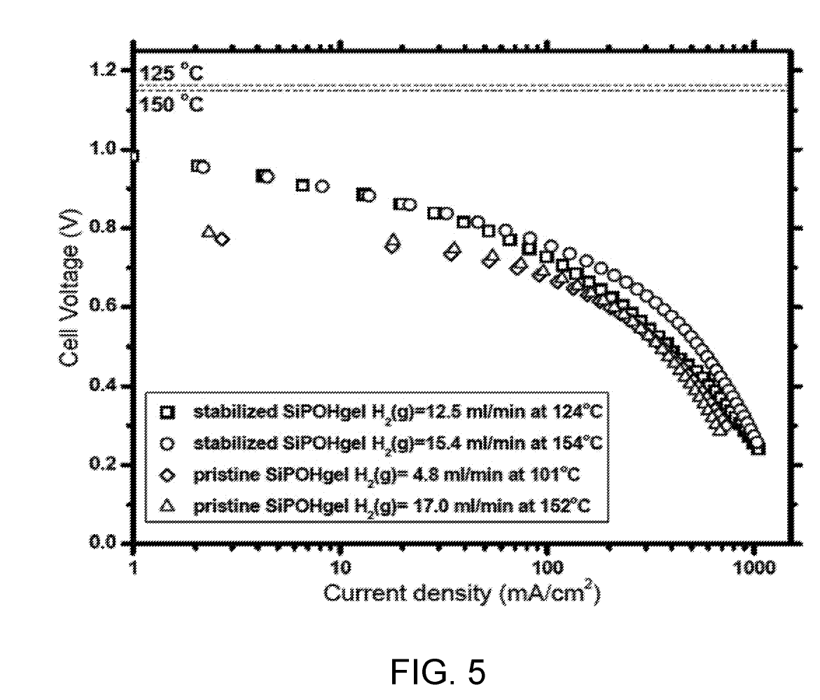

Noting the order of magnitude improvements in membrane performance obtained by coated substrates, a strong, flexible membrane was produced by incorporating a fiberglass wool filter (Cole-Palmer item QR-200 (Toyo Roshi Kaisha Ltd, Japan) ˜2 mm thick initially) as a supporting matrix. A coated (impregnated) substrate was formed as described herein, and the improved membrane (“stabilized SiPOHgel”) was placed in the cell assembly depicted in FIG. 4 between two standard E-TEK electrodes (LT140E—W; 0.5 mg Pt/cm²). To achieve a better contact between the electrode and the electrolyte, the assembled cell was left in a desiccator overnight, prior to testing. During the testing, the cell was left 2-3 hours at each temperature to ensure thermal equilibrium. The temperature of the cell was tracked relative to the oven atmosphere temperature during the test, for any indication of direct burning by fuel crossover. The polarization curves obtained using the improved membrane electrode assembly are shown in FIG. 5.

The Tafel plots (IR corrected) in FIG. 5 show fuel cell performance using the pristine SiPOHgel (lower curves—open diamonds and triangles) and the fiberglass-reinforced and dimensionally regular SiPOHgel membrane (upper curves—open squares and circles). The experiments used identical TEFLON fuel cell blocks with identical E-TEK electrodes. Different gaskets allowed for active areas of 0.5 cm² and 0.8 cm². Flow rates of H₂ for each electrolyte at each temperature are: stabilized SiPOHgel (open squares): H₂ (g)=12.5 mL/min at 124° C.; stabilized SiPOHgel (open circles): H₂ (g)=15.4 mL/min at 154° C.; pristine SiPOHgel (open diamonds): H₂ (g)=4.8 mL/min at 101° C.; and pristine SiPOHgel (open triangles): H₂ (g)=17.0 mL/min at 152° C. The flow rate for 02 was twice the H₂ flow rate. The dotted lines at the top of the diagram are the thermodynamic OCVs for 125° C. (upper) and 150° C. (lower). Membranes thinner than the stabilized SiPOHgel membranes, which had a thickness exceeding 2 mm, are expected yield higher currents and powers.

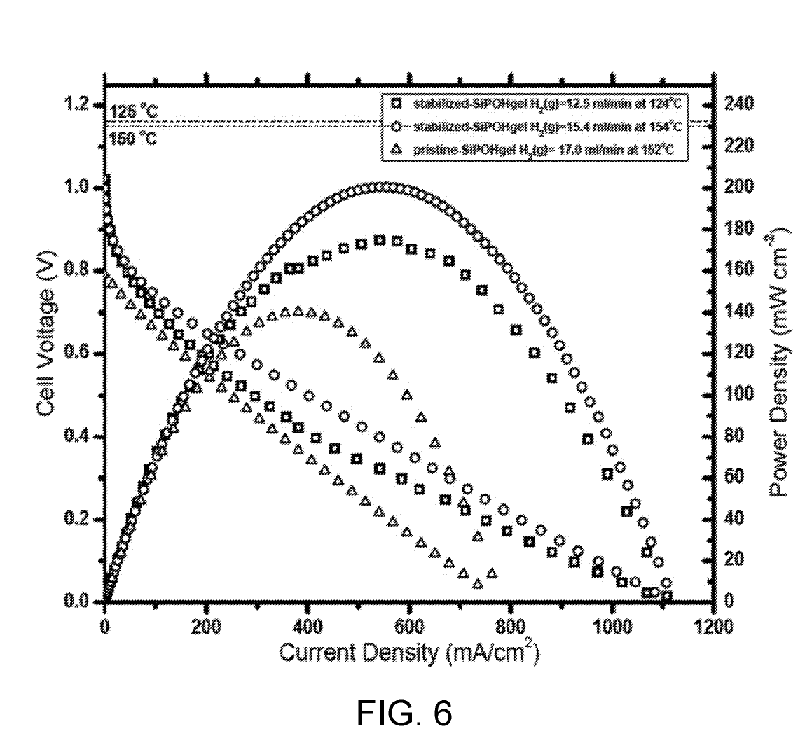

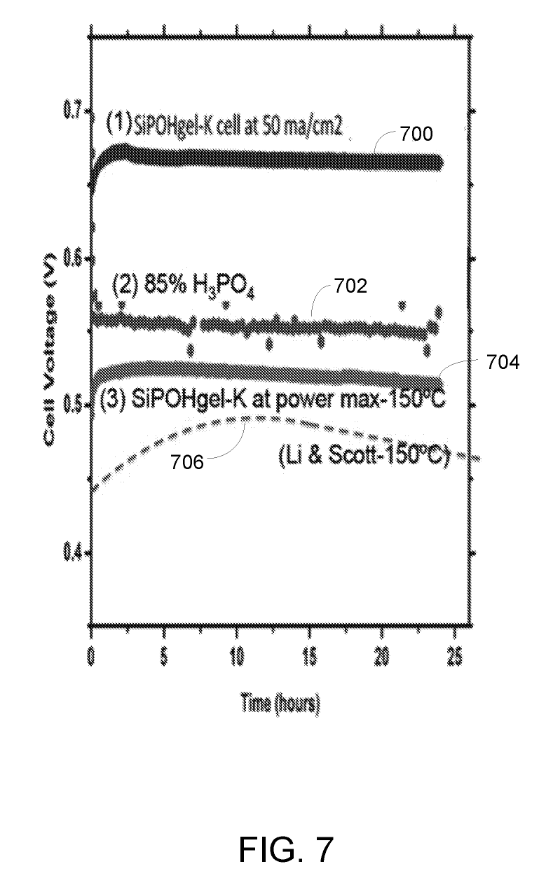

FIG. 6 shows polarization curves (linear current and no IR correction) and the corresponding power densities for the pristine SiPOHgel membrane at 152° C. (open triangles) and the fiberglass reinforced SiPOHgel membrane at 124° C. (open squares) and 154° C. (open circles). A power maximum of 202 mWcm⁻² was obtained at 0.4 V for the fiberglass-reinforced membrane at 154° C. (open circles).

As seen in FIG. 6, the OCV for the cell is above 1V. The maximum power output of 200 mWcm⁻² may be increased with improved cell design to decrease the slope of the FIG. 6 plot so that maximum power can be obtained at a higher potential (e.g., by using thinner supporting structures).

Membrane endurance under load (usually referred to as a degradation rate) was investigated by preparing a SiPOHgel membrane using an alternative preparation procedure. Used in the cell depicted in FIG. 4, but with a smaller cross-sectional active area, maximum power was reached at 187 mAcm⁻².

The cell with this SiPOHgel membrane was submitted to constant current tests of 24 hour duration (the maximum setting on a Parstat 2273 Advanced Electrochemical System) initially at a current density of 50 mAcm⁻² at 120° C. in order to compare with an earlier study using the same cell and the same E-TEK electrodes, but carried out using 85% phosphoric acid (liquid) as the electrolyte. The potential at 50 mAcm⁻² in the cell (plot 700) exceeded, by 20%, that of the cell using the same E-TEK electrodes, but with a liquid phosphoric acid (85% by weight) from Thomson et al., ECS Trans. 13 (2008) 21, which is incorporated by reference herein (plot 702), and remained constant over the entire 24 hour run. A further, and more severe, test was conducted at 151° C. at the current of maximum power, 187 mAcm⁻². In this case, a noticeable downward drift was detectable after about 12 hr, amounting to ˜0.01 mV (˜2%) over the 24 hour period (plot 704). This, however, is 5 times smaller than that in Li et al., with H₃PO₄-in-NAFION-PBI membranes (plot 706). It is expected that the very low “free” water content of the SiPOHgel membrane contributes to a reduction in the rate of Pt catalyst corrosion.

### Structure of SiPOHgel and Calcined SiPOHgel

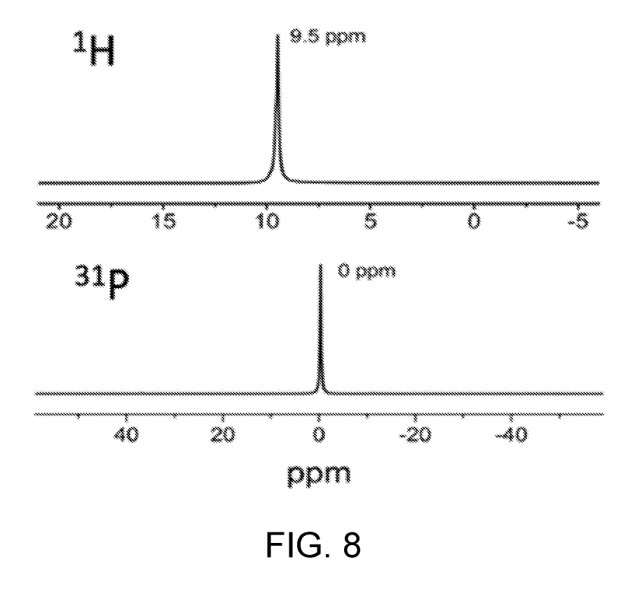

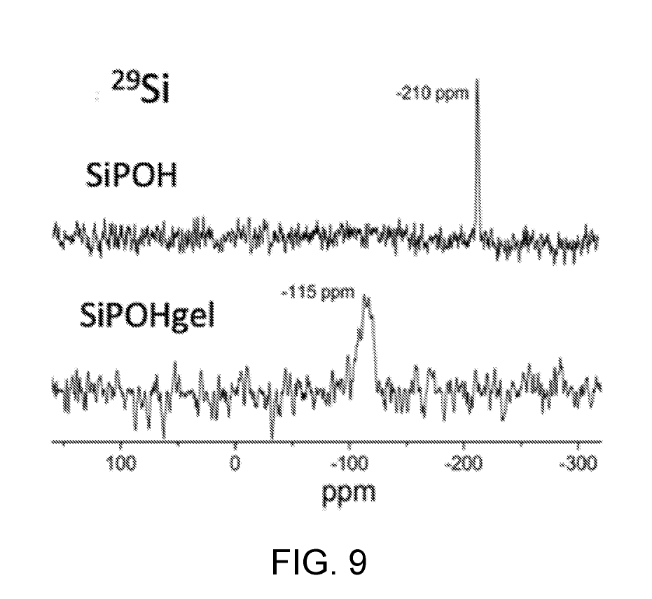

¹H and ³¹P NMR spectra of SiPOHgel are shown in FIG. 8. Sharp resonances at 9.5 ppm relative to TMS, and at 0.0 relative to H₃PO₄. The liquid-like sharpness of the lines, despite measurement in a standard liquid state spectrometer, is consistent with the observation of liquid-like conductivities in FIG. 3. The sharp spectral lines for ¹H and ³¹P resonances indicate liquid-like mobility in this flexible solid material. The fact that the resonances in both the ¹H and ³¹P NMR spectra are essentially those of phosphoric acid (H₃PO₄) suggests that the preparation procedure has caused a reorganization of the SiPOH particles described herein (which has silicon in six-fold coordination, as shown in FIG. 9) on a structural level, to produce a phosphoric acid gel for which the supporting structure is thought to be a silica network. That the Si:P ratio remains at 1:4, implies that the gel is a “tight” one. The length scales for silicate and H₃PO₄ components must remain comparable to maintain the 1:4 composition ratio.

A structure in which the phosphorous content is realized in H₃PO₄ molecular form, would be consistent with the finding of FIG. 3 that the thermal stability limit for high conductivity is around 150° C., the same as that attributed to phosphoric acid. That the supporting structure contains silicon in its normal 4-coordinated state (as opposed to the 6-coordinated state of silicon in ambient temperature SiPOH particles), is shown by the magic angle spinning (MAS) solid state NMR spectrum for Si in its natural abundance.

FIG. 9 shows solid state NMR spectra of ²⁹Si (natural abundance) in SiPOH paste (upper spectrum) and SiPOHgel (lower spectrum). The SiPOH paste spectrum shows a sharp resonance at −210 ppm that establishes the presence of silicon in six coordination. The SiPOHgel spectrum shows a resonance at ˜−115 ppm referenced to the standard TMS, (but using solid tetrakis(trimethylsilyl)silane (TTSS) as external secondary reference (TTSS −9.8 ppm)). A chemical shift of −115 ppm is at the downfield extreme of the chemical shift range for SiO₄ groups (i.e., 5 ppm beyond the average for the Q4 grouping given for silicate minerals and by various studies of the silica polymorphs, cristobalite, tridymite and quartz). That is, −115 ppm is at the edge of the range typical of silicon that is four-coordinated to bridging oxygens in tetrahedral silicate networks.

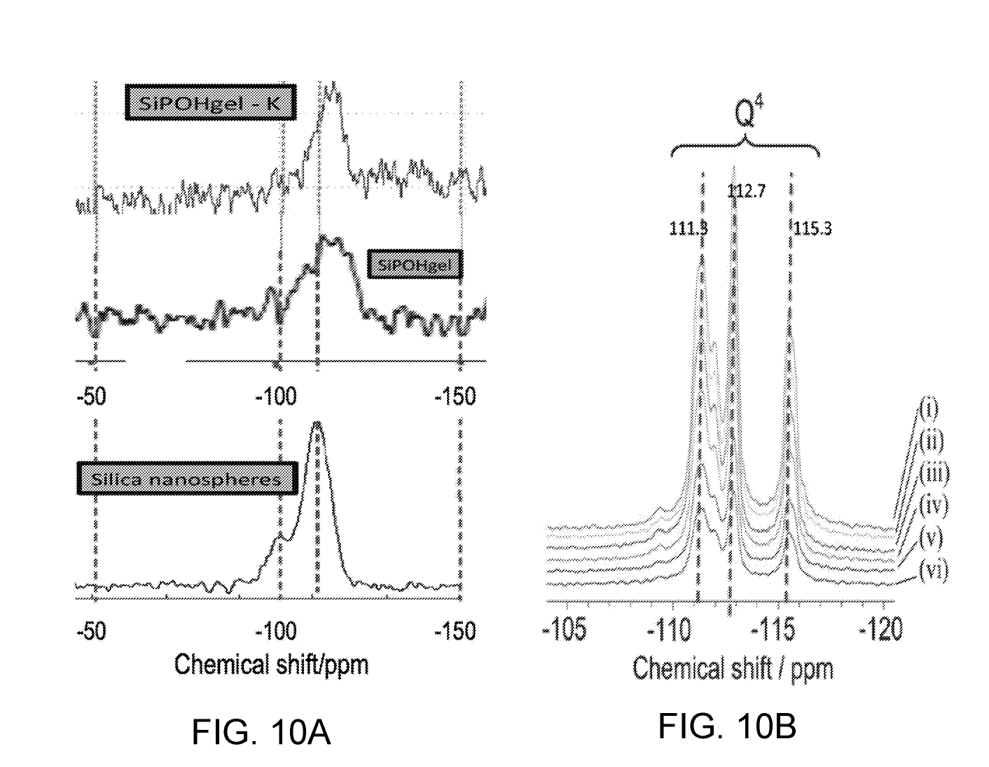

FIG. 10A shows ²⁹Si MAS-NMR spectra for SiPOHgel-K (upper spectrum) SiPOHgel (middle spectrum), and nanosphere SiO₂ (lower spectrum) showing the higher frequency resonances of the SiPOHgels. SiPOHgel-K and SiPOHgel were prepared with the same starting materials but by different methods. FIG. 10B shows Cu⁺ enhanced ²⁹Si MAS-NMR spectra of pure silica MCM-41 zeolite, which has two resonances in the domain of the SiPOHgel spectra. In FIG. 10B, (i)-(vi) indicate different levels of Cu⁺ doping.

To find ²⁹Si spectra more downfield than the −110 ppm of the common SiO₂ polymorphs, one must turn to pure silicas of zeolitic form. For instance, the aluminum-free form of MCM-41 has three main ²⁹Si resonances at −111.3, −112.7 and −115.3 ppm, as seen in FIG. 10B. Since SiPOHgel, in each of its preparations, has a broad resonance with the same average value of −115 ppm, as seen in FIG. 9, it is believed that SiPOHgel is an amorphous form of zeolitic silica, perhaps with even larger pores than MCM-41, for which the largest pore size is about 2.5 nm. Such a structure is thought to be unstable towards collapse to denser forms except for the support provided by the occluded H₃PO₄. That is, the structure of SiPOHgel is understood to be inherently “floppy” even though fully connected—which would account for the flexibility of SiPOHgel.

Since, by preparation, there are four phosphorous atoms for every silicon atom, and since the number of the H₃PO₄ molecules grows as the cube of the dimension of any nanodomain, the dispersion of H₃PO₄ in the silica network is expected to be nanoscopic, or at least highly ramified.

When the above observations are combined with the fact that the solid state NMR spectrum of ³¹P (not shown) produced no important new lines (a barely detectable resonance at −11 ppm is not considered significant), it may be concluded that there has been an almost total segregation of P from Si (as molecular H₃PO₄) in the SiPOHgel, all or nearly all Si—O—P bonds having been broken. The remaining structure is thought to be an open, floppy, pure silica network as the supporting structure. To account for the almost undiminished conductivity from that of pure H₃PO₄, the H₃PO₄ domains may be interconnected, or the proton hopping between H₃PO₄ domains may be free.

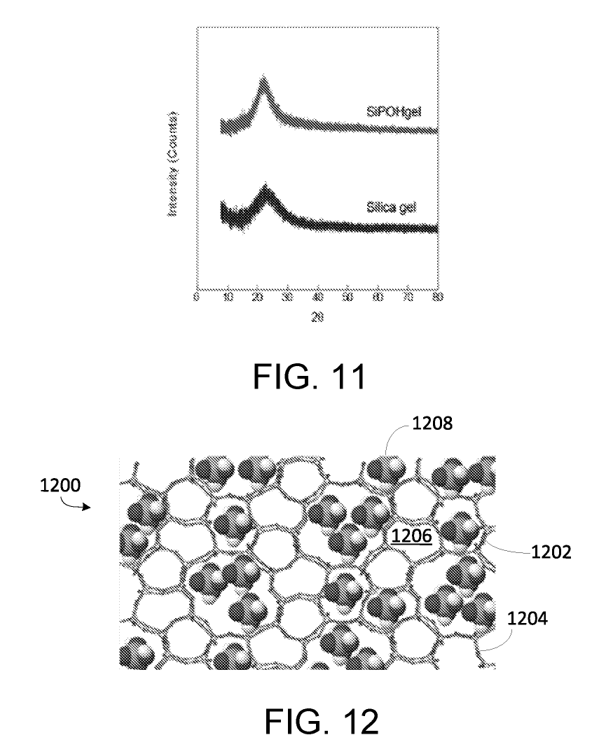

FIG. 11 shows XRD patterns of SiPOHgel (upper) and powdered silica gel (lower). The similarity of the SiPOHgel pattern to that of powdered silica gel, taken on the same diffraction equipment, is striking. The SiPOHgel pattern is simpler than that of hydrated silica gel. This comparison suggests that SiPOH is a fully connected amorphous silica network, with zeolite-like nanopore distributions of sufficiently floppy character to account for its flexibility. Occluded within the gel, and stabilizing its structure, appears to be a uniform distribution of essentially pure phosphoric acid. That is, the comparison suggests that SiPOHgel is a homogeneous network of siloxy units that might be slightly more correlated than those of silica gel, yet loosely enough connected that the structure remains floppy and easily, but elastically, deformable.

FIG. 12 depicts composition 1200 including a regular silica polymorph (silicalite) network 1202 with bridging oxygens 1204 and large pores 1206, in which phosphoric acid 1208 is contained. SiPOHgel as described herein is understood to be a randomized (i.e. amorphous) version of the depicted structure that retains the large pores. The phosphoric acid is typically in molecular form. The composition is a solid electrolyte in the form of a dried gel that can be used in the formation of a proton conductive membrane for a fuel cell. The composition is flexible and elastically deformable.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A composition comprising:
an amorphous silica network; and
phosphoric acid, wherein the phosphoric acid is contained in the amorphous silica network.

2. The composition of claim 1, wherein the phosphoric acid is in molecular form.

3. The composition of claim 2, wherein the composition is elastically deformable.

4. The composition of claim 1, wherein the silicon is in a four-coordinated state.

5. The composition of claim 1, wherein the ratio of silicon to phosphorous in the composition is about 1:4.

6. The composition of claim 1, wherein the composition is chemically stable up to 150° C.

7. The composition of claim 1, wherein the conductivity of the composition exceeds 200 mS/cm at 100° C.

8. The composition of claim 7, wherein the conductivity of the composition exceeds 300 mS/cm at 100° C.

9. The composition of claim 1, wherein the composition is all inorganic.

10. The composition of claim 1, wherein the composition is a dried gel.

11. The composition of claim 1, wherein the composition is a solid electrolyte.

12. A fuel cell membrane comprising the composition of claim 1.

13. The fuel cell membrane of claim 12, comprising a substrate.

14. The fuel cell membrane of claim 13, wherein the substrate is coated or impregnated with the composition.

15. The fuel cell membrane of claim 13, wherein the substrate is embedded in the composition.

16. The fuel cell membrane of claim 13, wherein the substrate is porous.

17. The fuel cell membrane of claim 16, wherein the substrate comprises a mesh, a matrix, a screen, a porous paper, or a porous polymer.

18. The fuel cell membrane of claim 13, wherein the substrate comprises glass wool.

19. The fuel cell membrane of claim 13, wherein the substrate is flexible.

20. A fuel cell comprising the fuel cell membrane of claim 13.

21. A method of preparing a fuel cell membrane, the method comprising:
reacting phosphoric acid in the liquid state with a compound comprising silicon and a displaceable ligand to yield a fluid suspension;
heating the fluid suspension to yield a liquid electrolyte comprising a particulate solid;
separating the particulate solid from the liquid electrolyte;
combining the particulate solid with water to yield a homogenous solution;
contacting a substrate with the homogeneous solution; and
removing water from the homogenous solution to yield the fuel cell membrane comprising the substrate embedded in a solid electrolyte.

22. The method of claim 21, wherein the solid electrolyte comprises an amorphous silica network and phosphoric acid, wherein the phosphoric acid is contained in the amorphous silica network.

23. The method of claim 22, wherein the phosphoric acid is in molecular form.

24. The method of claim 21, wherein the solid electrolyte is flexible.

25. The method of claim 21, wherein the solid electrolyte is a dried gel.

26. The method of claim 25, wherein the solid electrolyte is an anhydrous gel.

27. The method of claim 21, wherein the compound comprising silicon and the displaceable ligand is silicon tetrachloride.

28. The method of claim 21, wherein the compound comprising silicon and the displaceable ligand is a substituted or unsubstituted chlorophenyl silane.
